(19) United States
(12) Patent Application Publication
(10) Pub. No.: US 2005/0246059 A1
(43) Pub. Date: Nov. 3, 2005

(54) MLS-Hydroxyl Filling Station (MLS-HFS)

(75) Inventor: Stephen Foster Meyer, Golden Valley, MN (US)

Correspondence Address: STEPHEN F. MEYER, 12 N. MEADOW LANE, GOLDEN VALLEY, MN, 55422, US

(73) Assignee: Mr. Stephen Foster Meyer, Golden Valley, MN (US)

(21) Appl. No.: 10/709,215

(22) Filed: Apr. 22, 2004

(51) Int. Cl. G06F 17/00

(52) U.S. Cl. 700/231

(57) ABSTRACT

The utility of the MLS-HFS hydroxyl filling station, its configuration, design, and operation is the keystone of a new type of automation the production of hydroxyl gases from renewable resources.

### COPYRIGHT STATEMENT

copyright© 2001-2004 by Stephen F. Meyer, All right reserved.

### BACKGROUND OF INVENTION

Fuel cell and auto industries have been looking for methods and apparatus that can supply a source of hydrogen and oxygen for its new hybrid industry. This invention is such a device

### SUMMARY OF INVENTION

The invention is a computerizes automatic on site/mobile hydroxyl gas producing filling station that allows the products being produced to be used either by the hydrogen fuel cells installed in automobiles, trucks, buses, boats and land base generating applications or in any internal combustion engine.

### BRIEF DESCRIPTION OF DRAWINGS

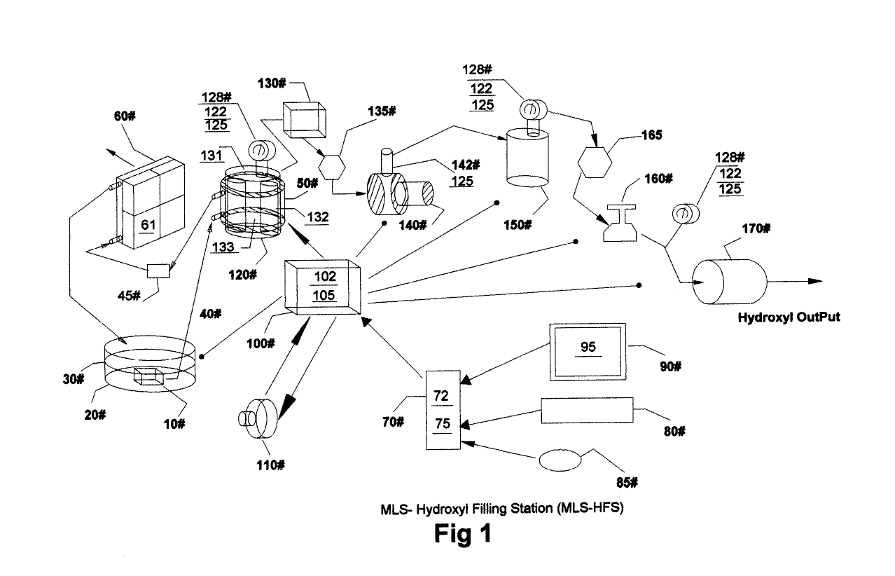

Drawing FIG. 1 shows the configuration of apparatus used in the MLS-hydroxyl filling Station (MLS-HFS).

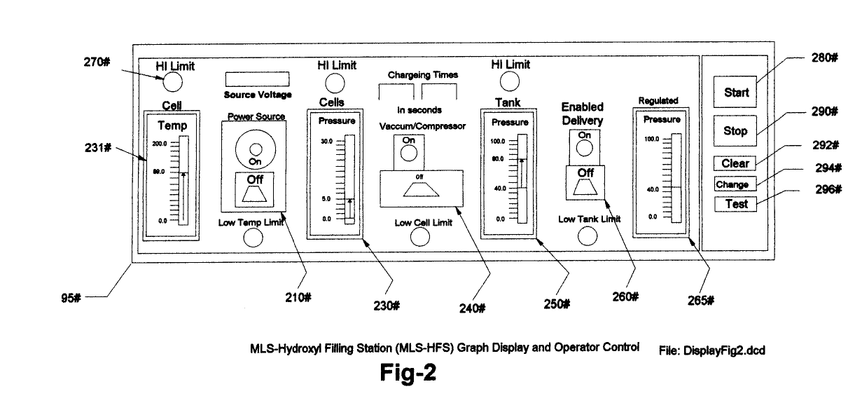

Drawing FIG. 2 shows the software display the operator uses to monitor and control the production of hydroxyl gases and heat.

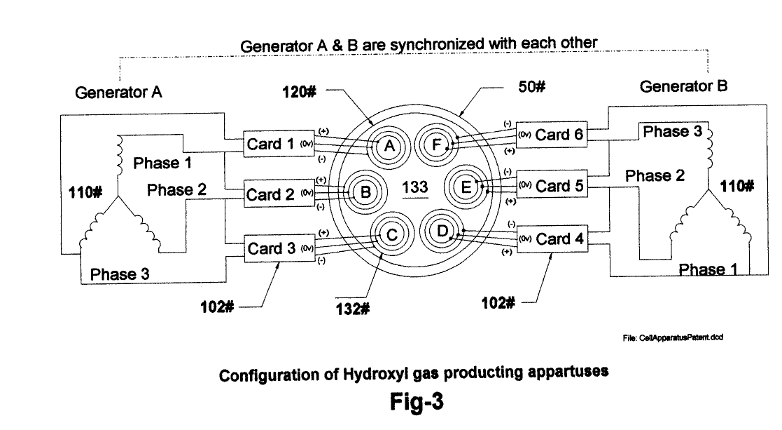

Drawing FIG. 3 shows the methods, configuration, and apparatus used in the hydroxyl producing cell 120 system.

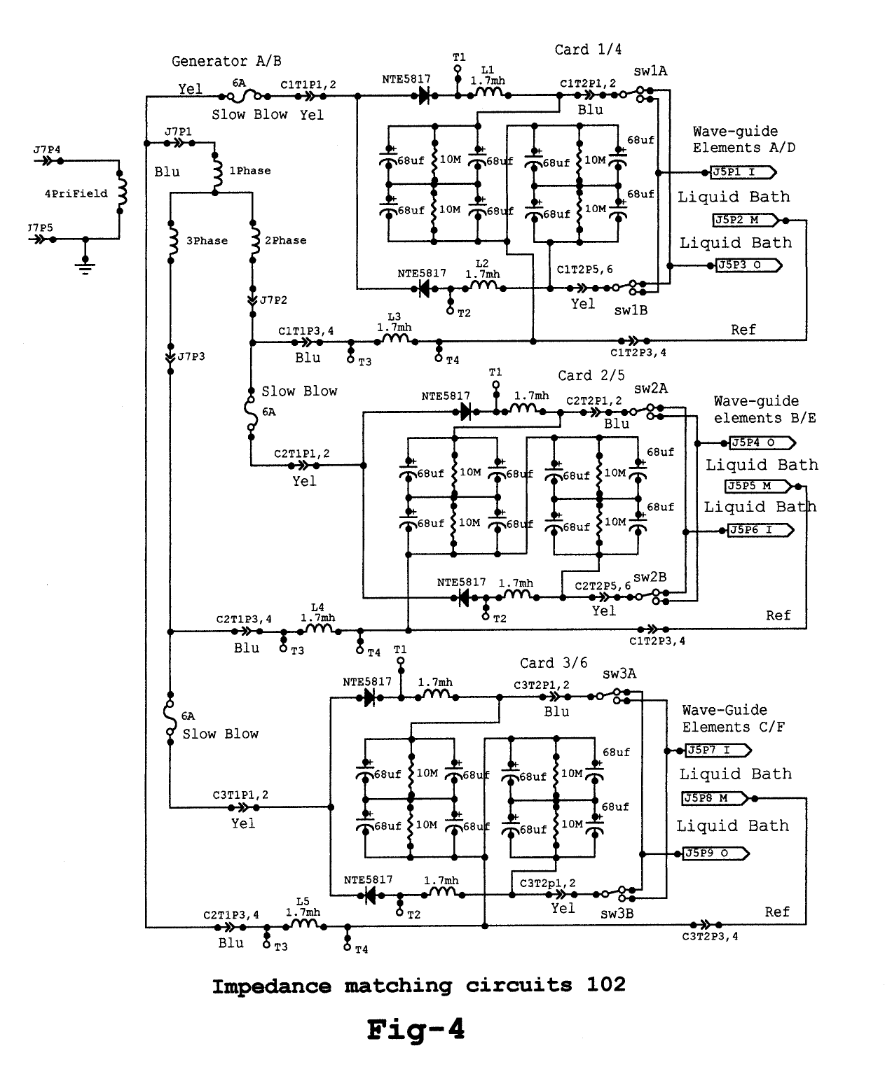

Drawing FIG. 4 shows the electronic impedance matching circuits 102 connected between the dual three phase generators (A&B) 110 FIG. 3 and each of the wave-guide arrays 132 in cell 120 FIG. 3. Note that only generator A is depicted in the drawing FIG. 4 as being connected to arrays A-B-C using PC cards 1-3. Generator B is connected to arrays D-E-F using cards 4-6.

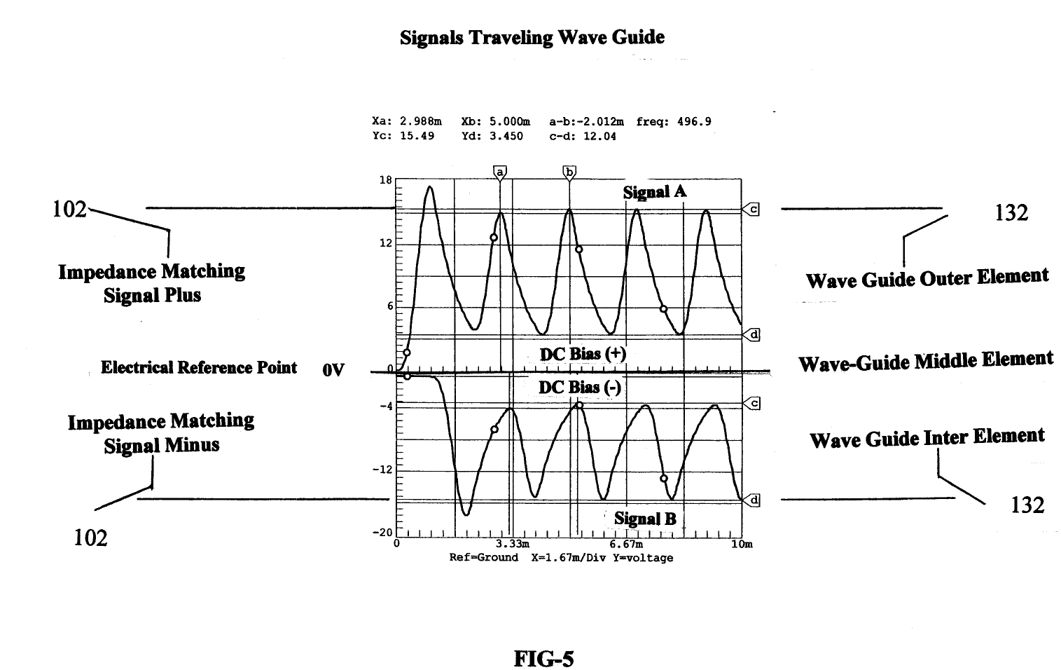

Drawing FIG. 5 shows the signals applied to each of the arrays 132 FIG. 3 installed in hydroxyl cell 120 emitted from each of the impedance matching circuits 102 FIG. 4 mounted on PC cards 1-6. These sets of signals FIG. 5 with their offsetting phase relationship, frequencies and amplitudes are the driving forces producing the hydroxyl gases in cell 120 FIG. 3.

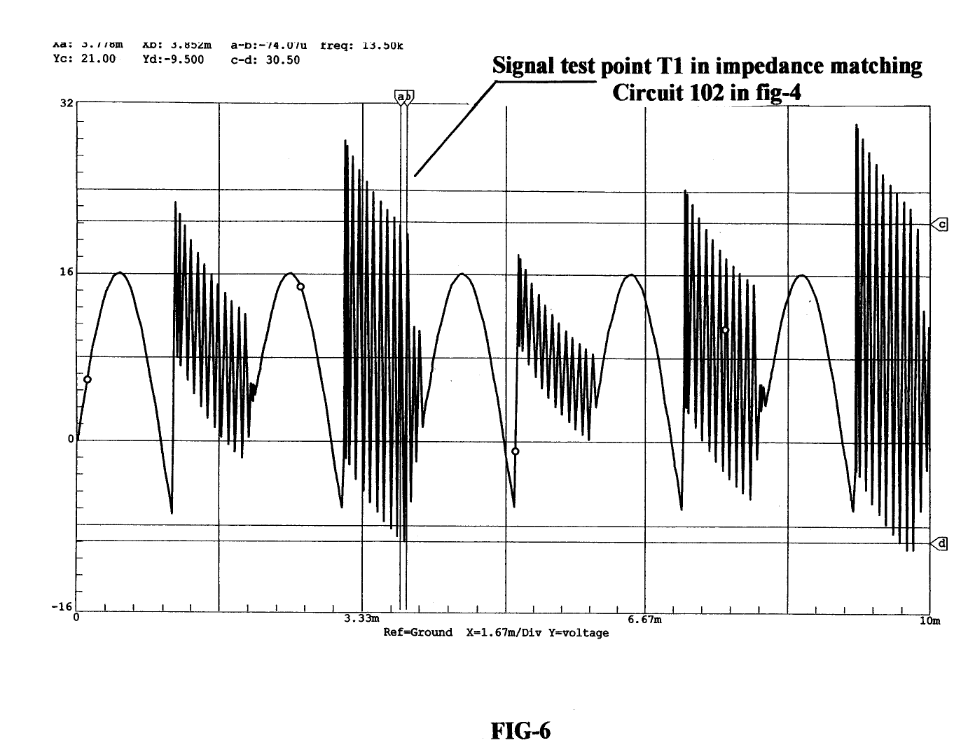

Drawing FIG. 6 shows the high frequency ringing signal located between test points T1 and T2 in impedance matching circuit 102 drawing FIG. 4. It is this ringing that also enhances the production of the hydroxyl gases in cell 120 FIG. 3.

### DETAILED DESCRIPTION OF THE DRAWINGS

FIG. 1

The heat removing section in FIG. 1 consist of a liquid bath 30 and its container 20, a liquid circulating pump 10, conveying conduits 40, cooling chamber 50 attached to hydroxyl generating cell 120, filter 45, radiator 60 and cooling fans 6l attached to it.

The automatic control section in FIG. 1 consist of a computer 70 software program 75 video monitor 90 and its graphic operator display 95 (FIG. 2) pointer 85 keyboard 80 interface card 72 and I/O controller 100 with its driver electronics cards 102 and 105.

Dual three phase power sources 110 and impedance matching circuits 102 provide the power needed to drive the hydroxyl cell 120.

The remaining apparatus are used to conduit the gases from cells 120, through liquid trap 130, through gas flow restriction valve 135, elevate its gas pressures through compressor 140, transfer them to storage tank 150. Then deliver the gases through safety cut off 165 regulators 160 through flash back arrestor 170 for external delivery.

FIG. 2

FIG. 2 shows the layout and functions of the operator control display 95 emulating from program 75 FIG. 1. It consists of cell temperature indicator 231 FIG. 2 cell power activator 210 cell pressure indicator 230 vacuum controller 240 hi-pressure tank indicator 250 delivery controller 260 delivery regulated pressure indicator 265 and related alarm/status indicators 270. Also software control buttons are provided to start 280 stop 290 clear data 292 change setting 294 and testing of equipment and their sequences 296.

FIG. 3

FIG. 3 shows the configuration of our proprietary hydroxyl producing apparatus 120 consisting of dual three phase power source 110 impedance matching electronic circuits 102 and gas converters devices 132 submersed in a bath of water 133 in cell 120. The drawing also shows the water jacket 50 surrounding the cell 120 that helps lower its temperature and allows more production of the hydroxyl gases at higher voltage signals FIG. 5.

FIG. 4

FIG. 4 shows the electrical circuits 102 used to drive the gas converting arrays 132 FIG. 3 submersed in a bath of water 133 in cell 120. The drawing FIG. 4 depicts three identical circuits connected to each of the three phase signals from ½ of the dual three phase generator A 110 FIG 3. The circuits 102 FIG. 4 convert the AC signal from each phase of 110 into a modulated signal as depicted by FIG. 5. These signals are then coupled to the triple array 132 elements (Inside, Middle, outside) by alternating the connection between the inside and outside elements of the arrays 132 FIG. 3.

FIG. 5

FIG. 5 Shows the composite signals applied to each of arrays 132 FIG. 3 submerges in water bath 133 in cell 120 and indicates the differential voltages used in the hydroxyl producing process MLS-HFS. Note that the center wave-guide element is used as the electrical reference point for both outside and inside elements of array 132. It is this composite signal applied to the surface of the stainless steel elements in array 132 submerge in water bath 133 that allow the ions from the elements in array 132 to cross its water 133 surface barriers and contribute to the hy-droxyl production. Note the dc bias voltage +,− on either side of the center electrical reference point OV in FIG. 5. It is this bias voltage being modulated by multi polarity differential signals from 102 FIG. 4 that contributes to the wave-guide action of arrays 132. Also, the frequency of FIG. 5 is adjusted to match the electrical wave-length of the arrays 132 FIG. 3 and the impedance of water bath 133.

FIG. 6

FIG. 6 shows the high-frequency ringing signals that contribute to the operation of the hydroxyl production. Just as a tuning fork rings when struck by a hammer, so does the wave-guide elements in arrays 132 immersed into the hydroxyl generating liquid 133 then struck by the electrical signals FIG. 5,6 from impedance matching circuits 102 depicted in FIG. 4.

Brief Description of Sequences

This invention is a computerized Hydroxyl gas producing filling station MLS-HFS designed to provide automatic control of its on site gas production and delivery.

The MLS-HFS FIG. 1 is a hydroxyl gas and heat generating system using a renewable source of liquid supply 30 such as water. It uses a computer control program 75 with display interface 95 for the monitoring, adjusting and controlling of the electronic and hardware apparatus and process logic. The electronic circuits 102 mounted in driver 100 controls the production of the gases and heating while circuit 105 control the process and routing of the hydroxyl gas.

The MLS-HFS consists of a low-pressure hydrolyser cell 120 FIG. 1, a liquid trap 130, an adjustable flow restriction value 135, high-pressure vacuum compressor 140, and check value 142 installed in 140. It also contains a high-pressure storage tank 150-alarm/low pressure cut off valve 165 gas regulator 160 flashback arrestor 170 and over pressure safety release valves 125 pressure gauges 128 and analog pressure sending units 122 installed on cell 120, tank 150 at the regulating side of regulator 160. Also 125 is installed on Compressor 140 high pressure out-put. The computer controller 70 monitor 90 keyboard 80 interface I/O card 72 and software position pointer 85 is used to control the production process using electronic driver 100 through its PC boards 105 and their attached control devices. The power to the cell driving circuits 102 installed in driver 100 is supplied from a dual three phase isolated power source 110. The amplitude, signal phases, and frequency from this power source is controlled by signal adjustments from the computer 70.

Detailed Description

Sequence of Operation

The MLS-HFS FIG. 1 is monitored and controlled by the soft-ware program 75-computer 70 monitors 90 keyboard 80 pointer 85 and display interface 95, FIG. 2.

The software program 75 FIG.1 has five main functions.

They are: to purge the system of ambient air, check and test for any equipment malfunctions, ready the system for production, monitor and control current activities of the production and safety shutdown of the system on detection of alarms.

During the initial installation and after any repairs the total system is purge via the vacuum pump 140 by manual rerouting valuing to ensure that all-ambient air has been removed from the system.

Before the system is put into service the operator via the graphic display 95, FIG. 2, keyboard 80 monitors 90 and pointer 85 can test the system for operation. The main functions of the testing is to ensure that the temperature electronics 131 attached to the hydroxyl cells 120 transferring compressor 140 and analog pressure sensors 122 mounted on cells 120 high pressure tank 150 and discharge side of regulator 160 used for control and monitoring are working properly. The operator then can activate the run sequence of the program 75via start software button 280 FIG. 2 on graphic display 95.

During the initial startup phase of the MLS-HFS system FIG. 1 the computer program 75 will configure the system for the purge sequence. This sequence will allow the vacuum pump 140 to draw down the hydroxyl cells 120 liquid trap 130 coupled to flow restriction value 135 and compressor 140 to removing all ambient air from them. Once the program 75 has detected no leaks, it then readies the system for gas production by routing the gas flow from 120 to high-pressure tank 150 and then to output flash back protector 170.

The program 75 starts off its production sequence by first turning on the cooling system consisting of liquid pump 10 that is submerse in liquid bath 30 contain in vessel 20. The cooling liquid 30 is pumped through cooling jacket 50 attached to the outside of cells 120 through Filter 45 and then through cooling air radiator 60. Fans attached to the radiator 60 are turned on for cooling.

Next the computer 70 turns on the dual three phase power source 110 that supplies the frequency, phase shifting and signals amplitudes to impedance matching circuits 102 FIG. 4 which is coupled to hydroxyl producing cells 120.

The result of this is just like the operation of a radio transmitter matching its signal to the air via the antenna impedance. Refer to FIG. 3 showing the relationship of this configuration to arrays 132, water bath 133 and Signals FIG. 5,6.

While the power source 110 is operating, computer 70 is monitoring the pressure 122 and temperature 131 of hydroxyl cell 120. When the cell pressures reaches a typical level of 5 pounds, the power source 110 is turned off and the compressor 140 is turned on starting the conveying of hydroxyl gases to high-pressure tank 150. When the hydroxyl cells 120 is drawn down to near zero pressure, the compressor 140 is turned off and power source 110 is turned back on starting the production cycle again.

The production cycle is repeated until tank 150 reaches a typical level of 80 pounds. At this time the computer 70 enables the output pressure regulator 160 set at a typical level of 40 pounds for the delivery of the hydroxyl gas to some external storage system or device.

During the production of hydroxyl gases computer 70 cycle the apparatus to maintain required levels. At the same time, the graphic display 95 indicates the activities of the system and alerts the operator of any malfunctions or process warnings.

Impedance Matching Circuit 102

The impedance matching circuits 102 FIG. 4 converts the sine-wave signals from the three phase power source 110 FIG. 3 into multi polarity differential signals FIG. 5 that are applied to the triple wave-guide clusters arrays 132 A,B,C,D,E,F installed in cell 120.

Its is this converted signal FIG. 5 along with the phase relationship of the power source 110 and the triple wave-guides element in cluster 132 that are submerge in a water bath 133 that produces the hydroxyl gases. It is important to note that not only is the gas produced between the elements in an array but also, between each array installed in cell 120 FIG. 3 (see array A-B-C phase relationship). Also that the array elements themselves are supplying much of the ions needed for the production of the gases.

Sequence of Hydroxyl Gas Generation

Once the hydroxyl-generating cell 120 has been purged of Ambient air and production routing completed (FIG. 1). The dual three-phase power source 110 is activated supplying frequency, amplitude, and phase signals to impedance matching circuitry 102. The converted signals from 102 are then applied to cell array 132 for processing. It is the combination of the impedance matching circuits 102-signal transformations FIG. 5,6; the cell configuration and materials used in arrays 132 and the rotational phase relationship between arrays AD, BE and CFand the submersion of these arrays 132 in a bath of water 133 that allows the MLS-HFS to produce large amounts hydroxyl gases. The computer program 75 and its graphic display 95 is used by the operator to adjust the rate of gas production and set the upper limit that the low pressure cell 120 will charge to.

After the cell 120 has reached its upper pressure cutoff limit (typically 5LBS). The power source 110 is turned off enabling the compressor 140 to start its draw down and transferring of the gases to the high-pressure tank 150. When the pressure in the cell 120 reaches a low-level limit (near zero LBS) 140 stops its charging cycle of 150. Check value 142 installed in 140 prevents any back flow of gases to 120 from the high-pressure tank 150. The power source 110 is then turned back on repeating the cycle. The charging cycles continual until high-pressure tank 150 reaches its upper pressure limit (typically 80 LBS) stopping the production of hydroxyl. As the gases are being used and/or transferred to external containers. The pressure is monitored for low-level cut-out limit (typicality 40 pounds) at pressure regulator 160 output . Once at this level the gas production cycle is restarted.

During cell 120 operations, the temperature is monitored for out of limit conditions set by control231 using the graphic display 95. Should the temperature reach an excess limit, the gas production is stopped and the computer program 75 alerts the operator of the problem. The cooling system 30 using water jacket 50 attached to cell 120 helps reduces the temperature 131 and allows for higher gas production.

After extended running times, the water in cell 120 is replenished by bath 30 and filtered by 45 to help control the operating impedance of the cell.

A listing related to software program 75 is depicted in text files attached to ePAVE and their file names are as follows: CombustAllP1 through CombustAllP19, Tank-TrackingDataFormP1-P2, TempTrackingFormP1-P2 and CellChargeTimeP1-P2.

1. The MLS-HFS information in this specification is the embodiment of the claims.

2. The system according to claim 1 further enhances the production of Hydroxyls based on the configuration of the Hydroxyl gas producing apparatuses FIG. 3.

3. The system according to claim 1 further enhances the production of hydroxyls based on the configuration of the impedance matching circuits FIG. 4.

4. The system according to claim 1 further enhances the production of hydroxyls based on the application of the electrical signals FIG. 5 applied to signal traveling wave-guides 132 submersed in a bath of water 133 installed in cell 120 and configured as depicted in FIG. 3.

5. The system according to claim 1 further enhances the production of hydroxyls based on the resonating action of electrical signals depicted in FIG. 6.

6. The system according to claim 1 further enhances the production of hydroxyls based on the software program 75 ability to control the production of hydroxyl gases; controlling its process limits, controlling its storage and controlling its delivery via operator controller FIG.2.

7. The software program 75 according to claim 6 further enhances the safety of the production of hydroxyls based on the monitoring of high and low limits and either alerting the operator of the condition/s and/or stopping the production on device failures via operator controller FIG. 2.

8. The software according to claim 6 further enhances the safety of the production of hydroxyls based on its ability to purge the system of ambient air before starting the production of hydroxyl gases.
